(19) United States
(12) Patent Application Publication
(10) Pub. No.: US 2002/0032792 A1
(43) Pub. Date: Mar. 14, 2002

(54) Method and apparatus for assisting to create home pages

(75) Inventors: Shigemasa Fukasawa, Fujisawa-shi (JP); Noriyuki Kaneko, Yokohama-shi (JP); Manabu Nakamura, Yokohama-shi (JP); Kouichi Maruyama, Yokohama-shi (JP)

Correspondence Address: PEARNE & GORDON LLP, 526 SUPERIOR AVENUE EAST, SUITE 1200, CLEVELAND, OH, 44114-1484, US

(73) Assignee: Matsushita Electric Industrial Co., Ltd.

(21) Appl. No.: 09/794,593

(22) Filed: Feb. 27, 2001

(30) Foreign Application Priority Data
Feb. 29, 2000 (JP) 2000-054479

(51) Int. Cl. G06F 15/00

(52) U.S. Cl. 709/231; 707/501.1

(57) ABSTRACT

The invention provides a system for assisting a net user having a home page on a web server to easily create a home page with live images uploaded. The invention is a home page creation assistance system and apparatus wherein user A having his/her home page and wishing to deliver live images on the home page accesses the home page creation home page in step ST1 to acquire information necessary for introducing the system; acquires an internet IP address in step ST2; makes application for home page creation assistance and sends information on the live image acquisition means and information on the live image display specifications on the home page in step ST3; waits for the source codes to be received in step ST4; and pastes the received source codes on the home page in step ST5.

### BACKGROUND OF THE INVENTION

The present invention relates to a method and apparatus for assisting a net user having a home page on a web server to upload live images as contents of the home page.

With the advancement of wide area networks such as the internet, it is readily possible to create a home page on a server connected to a network and originate information specific to each user. In order to enhance the additional values of the home page, delivery of live images is performed, such as delivery of advertisement images by stores aiming at collecting customers and observation images of resorts. Moreover, new businesses aim at delivering live images to specific viewers.

However, it is not necessarily easy to install, adjust and maintain a camera for shooting live images and an interface unit for delivering images on the network. This makes it difficult to deliver live images on a home page. Creation of a home page where a viewer of live images can control the camera operation requires further knowledge, and is difficult in particular for personal users and small-to-medium company users.

The invention aims at solving such problems and provides a system for assisting a net user having a home page on a web server to easily create a home page with live images uploaded.

### SUMMARY OF THE INVENTION

The invention makes it unnecessary to arrange for installing and adjusting live image acquisition means such as a camera and to create source codes to be pasted on a home page, by sending information on the live image display specifications on the home page to a home page creation assistance computer connected to the network.

### BRIEF DESCRIPTION OF THE DRAWINGS

FIG. 1 shows a schematic configuration of an entire system according to the invention;

FIG. 2 is a schematic flow of creating s home page with live images uploaded;

FIG. 3 is an example of an initial menu of assistance by the home page creation assistance server;

FIG. 4 is a flow of assistance application processing by the home page creation assistance server;

FIG. 5 is a flow of modification application processing by the home page creation assistance server.

In the figures, 1 represents the internet, 2 a web page, 3 a digital camera, 4 a network interface, 5 a router, 6 a home page creation assistance server, 7 a relay server, 8, 9 viewers' computers, and 10 an information display terminal such as a portable telephone set and a car navigation system.

### DETAILED DESCRIPTION OF THE PREFERRED EMBODIMENTS

### First Embodiment

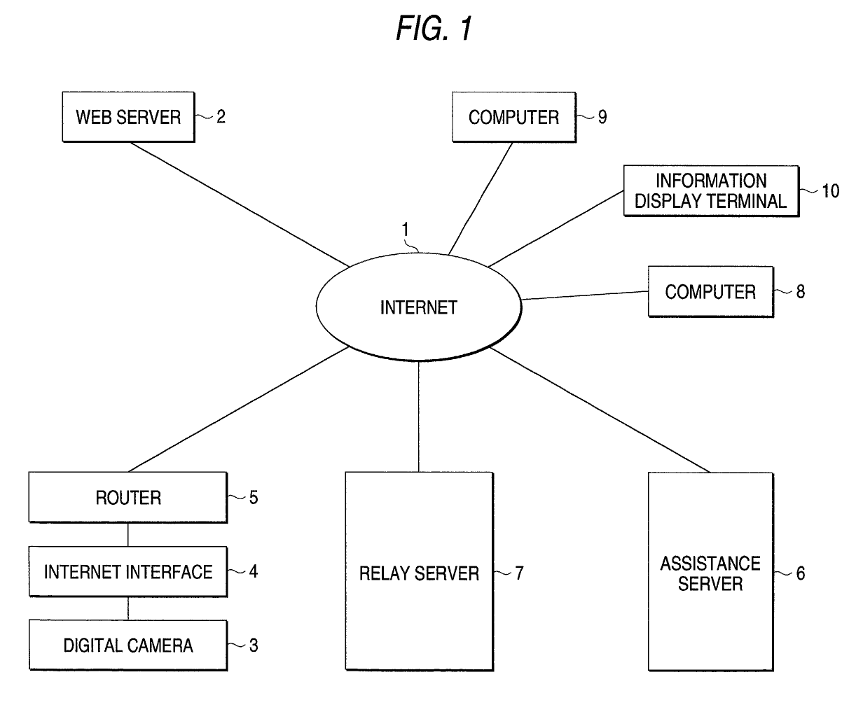

FIG. 1 shows a schematic configuration of an entire system according to the invention. A web server 2 is connected to the internet 1. A home page of user A is created on the server 2. A camera 3 such as a digital camera, connected to the internet via a network interface 4 and a router 5, shoots live images uploaded on the home page of user A. A home page creation assistance server 6 assists a user to upload live images on his/her home page. A relay server 7 relays transmission of live images. Computers 8, 9 are computers used by viewers to watch live images. Information display terminals 10 are substitutes for the computers 8, 9.

When a viewer using computers 8, 9 or information display terminals 10 as their substitutes views a live image on the home page of user A on the server 2, the live image shot by the camera 3 is sent to and displayed on the computer 8, 9 via the network interface 4, the router 5, and the relay server 7. The image displayed contains buttons for operating the live image. The viewer operates the buttons to control the camera 3 so that the screens may shifted or scaled up/down.

Creation of a home page with live images uploaded is made under assistance of the home page creation assistance server 6.

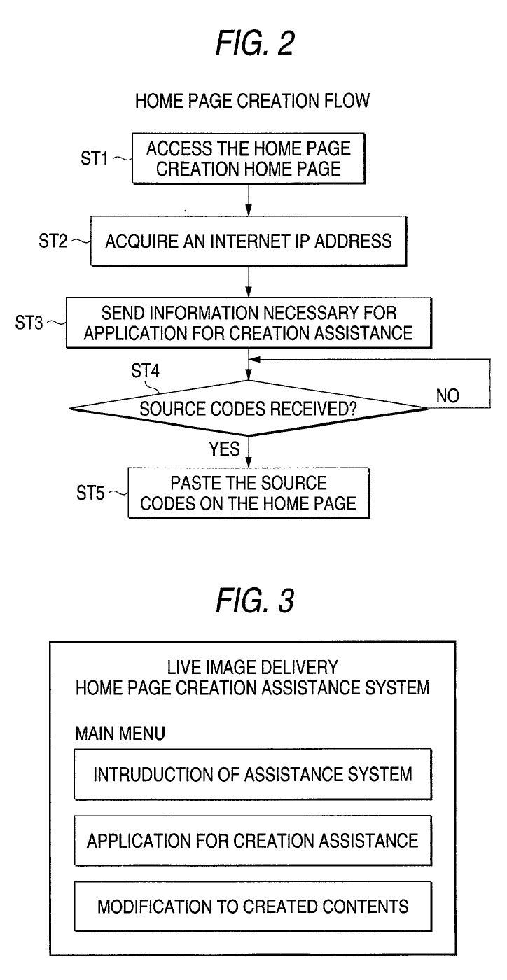

In case user A having a home page on the server 2 shown in FIG. 1 whishes to deliver live images on his/her home page, he/she accesses the home page of the home page creation assistance server 6 to make predetermined application. The flow of the corresponding procedure is shown in FIG. 2.

In step ST1, user A accesses the home page creation assistance home page of the server 6 to acquire information necessary for introducing the system. User A, knowing that an internet IP access for the camera is required to deliver images, acquires an internet IP address in step ST2. In step ST3, user A makes application for home page creation assistance and sends necessary information. The information includes information on the applicant such as the name, mail address and payment information for the assistance service, including credit number, of the applicant, information on the live image acquisition means such as the internet IP connection address for the camera, and information on the live image display specifications on the home page.

Information on the live image acquisition means includes the installation position of the shooting camera, installation environment, specifications of the equipment such as the shooting camera, information on selection of lease/purchase, and information on maintenance specifications. Internet IP connection address may be sent later because it usually takes time to acquire the address, as well as the internet IP connection address.

Information on the live image display specifications includes the size and display position of live images to be displayed and information on the operation specifications of the means for shooting the live images.

When image shooting and installation and adjustment of delivery equipment are complete, source codes are sent. In step ST4, user A waits for the source codes to be received and in step ST5, user A pastes the received source codes on the home page. The source codes are HTML codes as shown in [FORMULA 1] or [FORMULA 2] so that simply pasting the source codes on a home page uploads a live image on the home page.

FORMULA 1
<HTML>
<HEAD>
<TITLE>Punasonic Network Interface Unit WJ-NT 104 MAINVIEW
M 320 1/50f</TITLE>
</HEAD>
<BODY BGCOLOR=“#FFFFFF” topmargin=0 leftmargin=0
marginwidth=0 marginheight=0
<IMG SRC=http://cyberweeb.mci.punasonic.co.jp/live/jpegcat.
cgi?id=947741666&PAGE=951181747310 NAME=Camlmg onL
oad=“TimerID=setTimeout(‘loadcamera()’,50), ”WIDTH=320 HEIG
HT=240></A>
</BODY>
</HTML>

FORMULA 2
<HTML>
<HEAD>
<TITLE>Punasonic Network Interface Unit WJ-NT 104 MAIN
VIEW[preset selection]</TITLE>
</HEAD>
<BODY BGCOLOR=“#FFFFFF”
<A HREF=“http://cyberweeb.mci.punasonic.co.jp/live/view.cgi?command=
request&id=948415796&ch=1”TARGET=“VIEWS”>1.XXXXX(place

name)</A></BR>

<A HREF=“http://cyberweeb.mci.punasonic.co.jp/live/view.cgi?command=
request&id=948415796&ch=2”TARGET=“VIEWS”>2.XXXXX(place

name)</A></BR>

<A HREF=“http://cyberweeb.mci.punasonic.co.jp/live/view.cgi?command=
request&id=948415796&ch=3”TARGET=“VIEWS”>3.XXXXX(place

name)</A></BR>

<A HREF=“http://cyberweeb.mci.punasonic.co.jp/live/view.cgi?command=
request&id=948415796&ch=4”TARGET=“VIEWS”>4.XXXXX(place

name)</A></BR>

<A HREF=“http://cyberweeb.mci.punasonic.co.jp/live/view.cgi?command=
request&id=948415796&ch=5”TARGET=“VIEWS”>5.XXXXX(place

name)</A></BR>

<A HREF=“http://cyberweeb.mci.punasonic.co.jp/live/view.cgi?command=
request&id=948415796&ch=6”TARGET=“VIEWS”>6.XXXXX(place

name)</A></BR>

<A HREF=“http://cyberweeb.mci.punasonic.co.jp/live/view.cgi?command=
request&id=948415796&ch=7”TARGET=“VIEWS”>7.XXXXX(place

name)</A></BR>

<A HREF=“http://cyberweeb.mci.punasonic.co.jp/live/view.cgi?command=
request&id=948415796&ch=8”TARGET=“VIEWS”>8.XXXXX(place

name)</A></BR>

</BODY>
</HTML>

Next, operation of the home page creation assistance server 6 connected to the internet will be described. The assistance server 6 displays the screen shown in FIG. 3 as an initial menu of the assistance to let the user to select it.

When it is examined whether to enjoy the image delivery service, the assistance server selects the assistance system introduction and displays the outline of the image delivery service and the demonstration screen.

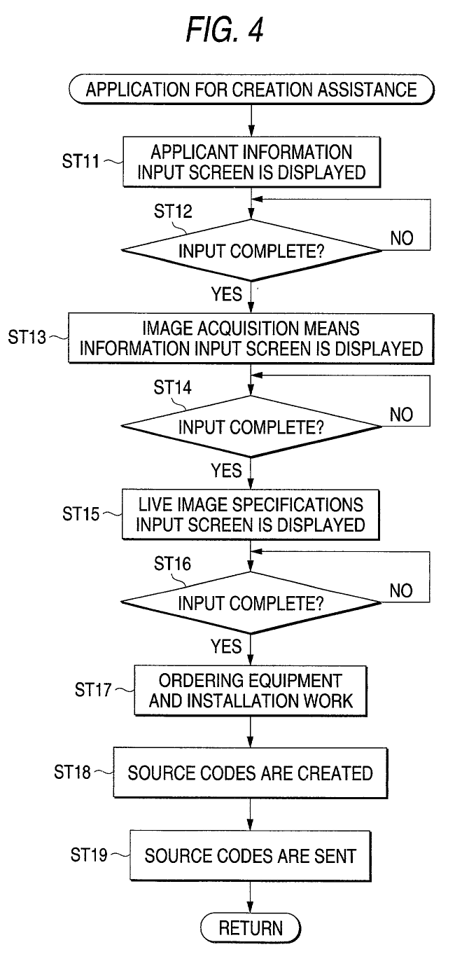

The flow used when assistance application is selected from the initial menu is shown in FIG. 4. In step ST11, the input screen for the information on the applicant is displayed. In step ST12, input from the user is confirmed. In step ST13, the information input screen concerning the image acquisition means is displayed. In step ST14, input from the user is confirmed. In step ST15, the information input screen concerning the live image display specifications is displayed. The screen is preferably adapted to select a model display screen.

When input is confirmed in step ST16, ordering of equipment and installation work is instructed (step ST17) then source codes are created (step ST18) . Finally, after the installed equipment is adjusted and the created source codes are checked, the source codes are sent in step ST19. The source codes may be directly written on the home page of the applicant, if possible.

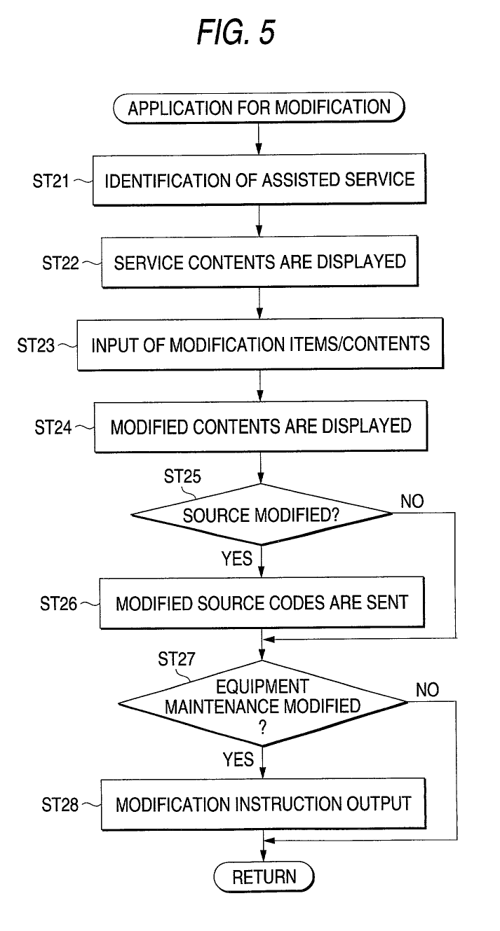

Operation made when application for modification is selected from the initial menu is shown in FIG. 5. When the assisted service is identified via the name of the applicant (step ST21), the content of the service is displayed in step ST22. After the modification item and modification contents are input in step ST23, the modified contents is displayed in step ST24 for user's confirmation.

Then, the necessity of modifying the source codes is examined based on the modification (step ST25). In case modification is necessary, the modified source codes are sent (step ST26), necessity of modifying equipment and maintenance is examined and modification is instructed if necessary.

### SECOND EMBODIMENT

While live images uploaded on a home page are viewed without restriction in the first embodiment, the viewer may be requested to enter a registered ID and password or charged a viewing rate. In particular, in a charged-viewing system, a configuration is preferable for a new image delivery business where source codes are created to send billing information to the assistance computer, proxy charge collection is made in cooperation with a credit company, and the charge is settled together with the equipment lease/maintenance charge.

As understood from the foregoing description, the invention provides a method and apparatus for assisting a net user having a home page to easily create a home page with live images uploaded.

What is claimed is

1. A home page creation assistance method for assisting a net user to upload live images to home page on a web server by using an assistance computer connected to a network, said method comprising:
a step of outputting live image display source codes created based on the network connection address information from an assistance requester and the display specification information concerning the live image display specifications on the home page to said requester's computer.

2. A home page creation assistance method according to claim 1, comprising a step of writing said source codes on said requester's homepage instead of outputting said live image display source codes to said requester's computer.

3. A home page creation assistance method according to claim 1 or 2, wherein the information on said live image acquisition means includes the specifications and installation environment of means for shooting live images and information on maintenance of the live image acquisition means,
said method further comprising a step of outputting instruction information for installation andmaintenance agents.

4. A home page creation assistance method according to any of the preceding claims, wherein the information on said live image display specifications includes the size and display position of live images to be displayed and information on the operation specifications of the means for shooting said live images.

5. A home page creation assistance method according to any of the preceding claims, wherein the information on said live image acquisition means and the information on said live image display specifications can be modified after the home page has been created.

6. A home page creation assistance method according to any of the preceding claims, wherein said live image display source codes contain a source code for performing billing control over live image viewing and billing information for viewing is sent to said assistance computer.

7. Homepage creation assistance apparatus for assisting a net user to upload live images to his/her home page on a web server by using an assistance computer connected to a network, said apparatus comprising
a means for of outputting live image display source codes created based on the network connection address information from an assistance requester and the display specification information concerning the live image display specifications on the home page to said requester's computer.

8. Home page creation assistance apparatus according to claim 7, comprising means for writing said source codes on said requester's home page instead of outputting said live image display source codes to said requester's computer.

9. Home page creation assistance apparatus according to claim 7 or 8, wherein the information on said live image acquisition means includes the specifications and installation environment of means for shooting live images and information on maintenance of the live image acquisition means,
said apparatus further comprising means for outputting instruction information for installation and maintenance agents.

10. Home page creation assistance apparatus according to any of claims 7 to 9, wherein the information on said live image display specifications includes the size and display position of live images to be displayed and information on the operation specifications of the means for shooting said live images.

11. Home page creation assistance apparatus according to any of claims 7 to 10, wherein the information on said live image acquisition means and the information on said live image display specifications can be modified after the home page has been created.

12. Home page creation assistance apparatus according to any of claims 7 to 11, wherein said live image display source codes contain a source code for performing billing control over live image viewing and billing information for viewing is sent to said assistance computer.
